(19) United States
(12) Patent Application Publication
(10) Pub. No.: US 2014/0062125 A1
(43) Pub. Date: Mar. 6, 2014

(54) VEHICLE DEVICE

(71) Applicant: Aerotails Limited, Bath (GB)

(72) Inventor: Edward Walid Antoine Elias, Bath (GB)

(73) Assignee: Aerotails Limited, Bath (GB)

(21) Appl. No.: 14/016,873

(22) Filed: Sep. 3, 2013

(30) Foreign Application Priority Data
Sep. 4, 2012 (GB) GB 1215714.5

(51) Int. Cl. B62D 35/00

(52) U.S. Cl. CPC B62D 35/001
USPC 296/180.1

(57) ABSTRACT

An aerodynamic device 24 for fitting to a vehicle 1 comprising a load compartment 10 having a roof 16 with front section 22, which is the section of the roof 16 towards an edge 20 of the roof 16 that is forward-most in relation to the direction of travel of the vehicle 1. The device 24 has an air guiding member 26 and an attachment structure 32 for attaching the member 26 to the vehicle 1 in a first, active position in spaced apart relation to the front section 22 of the roof 16 thereby to define an airway 34 between the member 26 and the front section 22 of the roof 16.

### CROSS-REFERENCES TO RELATED APPLICATIONS

This Application claims the benefit under 35 U.S.C. §119 of Patent Application No. GB 1215714.5 filed Sep. 4, 2012, which is incorporated herein by reference in its entirety as if fully set forth herein.

### TECHNICAL FIELD

The invention relates to a device for improving the aerodynamic performance of vehicles, particularly, although not exclusively, road vehicles. The invention also relates to a vehicle fitted with such a device and to a method of fitting such a device to a vehicle.

### BACKGROUND ART

A road vehicle usually comprises a traction unit and a load compartment. These may be separate, as in the case of, for example, an articulated lorry, where traction is provided by a self-propelled truck that tows a load carrying trailer including a load compartment in the form of a goods container. Alternatively, the traction unit and load compartment may be integrated, as in the case of, for example, a van, where the load is goods, or, for example, a car, where the load is passengers.

A moving vehicle is subject to drag due to the frictional force exerted by the air flowing over its body. By optimising the aerodynamic performance of a vehicle, the effects of drag can be reduced. Smooth or laminar airflow over a vehicle's body is preferred because it creates less drag. Turbulence, for instance, caused by air leaving a body as it flows past, has an adverse effect on the vehicle's aerodynamic performance.

A vehicle's fuel efficiency is affected by its aerodynamic performance. Fuel efficiency has implications for the cost of running the vehicle and its environmental impact. In the interests of improving fuel efficiency, considerable development has gone into improving the aerodynamic performance of vehicles.

In the case of articulated lorries, for example, turbulent airflow past the load compartment has been one focus of development attention. Typically, the load carrying container of an articulated lorry has a rectangular box-like construction which is good from a loading perspective but not from an aerodynamic perspective. The flat, forward facing side of the container is a particular source of turbulence because it disrupts smooth airflow. Attempts to overcome this disruption have included using a spoiler or deflector fitted to the roof of a truck to deflect the air up and over the container, or providing elongate, vertically extending side collars mounted at each side of the truck, which are configured to deflect air down the side of the container. In addition, the roof of the container may be curved from front to back so as to direct air up and over it.

There is still scope for further improvement of the aerodynamic performance of vehicles.

### SUMMARY OF THE INVENTION

According to a first aspect, the invention provides an aerodynamic device for fitting to a vehicle comprising a load compartment having a roof, wherein the roof has a front section which is the section of the roof towards an edge of the roof that is forward-most in relation to the direction of travel of the vehicle, the device comprising an air guiding member and an attachment structure, wherein the attachment structure is for attaching the member to a vehicle in a first, active position in spaced apart relation to the front section of the roof thereby to define an airway between the member and the front section of the roof.

Having an airway between the member and the front section of the roof and the resultant airflow through the airway improves the aerodynamic performance of the vehicle by promoting smooth airflow over a large part of, if not all, the roof to the rear of the device and, in particular, minimising the tendency of the airflow past the roof to leave the roof and become turbulent.

The device according to the invention is employable on, and may improve the aerodynamic performance of, many types of vehicles. The device according to the invention is particularly applicable to road vehicles. In the case of an articulated lorry comprising a truck and a trailer including a load carrying container, the forward-most edge of the roof of the container may be where the roof meets the front, forward facing side of the container. Also in the case of an articulated lorry, a deflector may be mounted on the roof of the truck, in front of the container, to assist in guiding air through the airway. Such a deflector may also be employed on non-articulated lorries. In the case of a van or car, the forward-most edge of the roof may be where the roof meets the windscreen surround. The roof and whatever it meets need not be at, near or less than right angles in order to define an edge. Angles between the roof and whatever it meets that are greater than right angles will also define an edge.

The member may be sheet- or plate-like in the sense that it may be relatively longer and wider than it is thick. The thickness may be non-uniform across the length and/or width of the member. For example, the member may have an aerofoil- or wing-like profile from front to rear.

The member may be curved from front to rear and/or side to side. The curvature may be generally smoothly continuous or the member may comprise two or more planar sections, with each planar section being at an angle with respect to an adjacent planar section.

The member may extend forward to a position forward of the forward-most edge of the roof. The member may extend backwards towards or to a rear section of the roof. The member may extend to a position below the forward-most edge of the roof.

The attachment structure may comprise a pair of arms, each extending between a part of the member and a part of the vehicle. The attachment structure may be adjustable for attaching the member in other active positions in which the member defines an airway and is at a different spacing from and/or inclination to the front section of the load compartment roof and/or in an inactive, stowed position in which the member does not define an airway. In addition, the attachment structure may be adapted so that the device can be removed altogether from the load compartment.

According to a second aspect, the invention provides a vehicle to which a device according to a first aspect of the invention has been fitted. The device may be fitted to the vehicle during its manufacture or at some later point in its life.

According to a third aspect, the invention provides a method of fitting a device according to the first aspect of the invention to a vehicle.

According to a fourth aspect, the invention provides an aerodynamic device, comprising an air guiding member to modify an aerodynamic signature of a vehicle to which the device is mounted, the member to define an air guiding channel between an underside thereof and a portion of the roof of the said vehicle whereby to induce a laminar airflow over the vehicle roof.

### BRIEF DESCRIPTION OF THE DRAWINGS

FIG. 1 is a perspective view of an articulated lorry to which a device according to the first aspect of the invention has been fitted;

FIG. 2 is a side view of the articulated lorry shown in FIG. 1; and

FIGS. 3a-c are airflow diagrams comparing the effects of employing a device according to the first aspect of the invention against prior art devices for reducing turbulence in the airflow past a vehicle.

### DESCRIPTION OF EMBODIMENTS

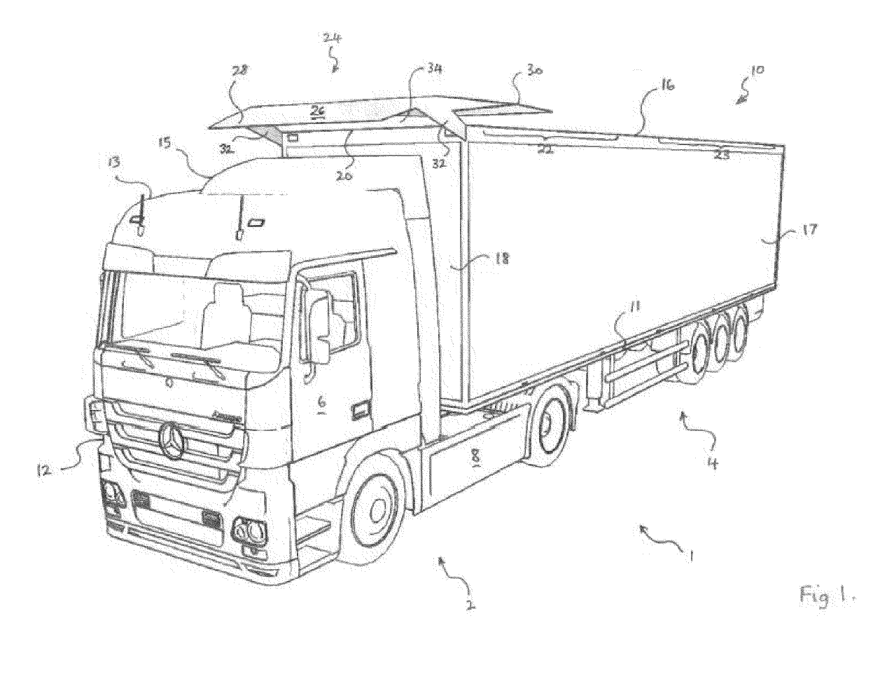

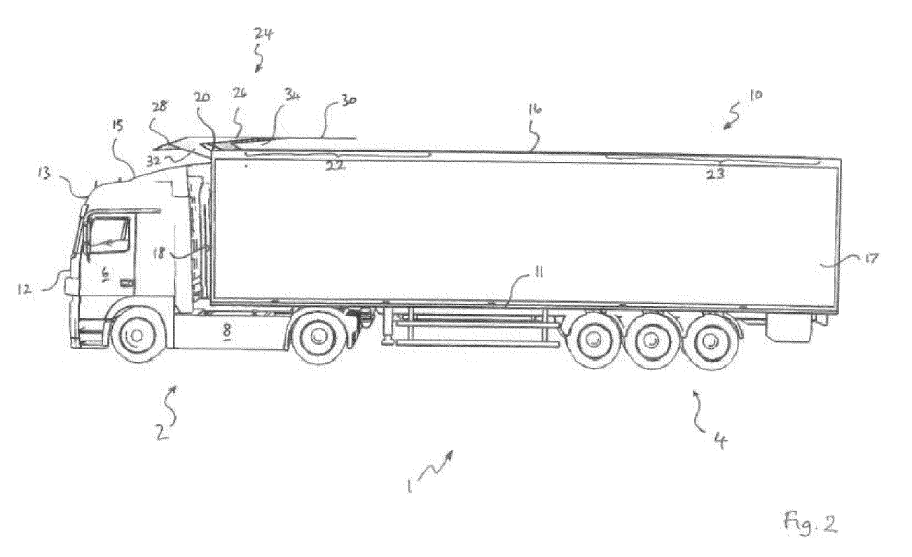

With reference to FIGS. 1 and 2, an articulated lorry indicated generally at 1 comprises a truck 2 and a trailer 4. In a conventional manner, the truck 2 tows the trailer 4, such that the forward direction of the lorry 1 is from right to left as viewed in the figures. The truck 2 and the trailer 4 are connected at a joint (not shown).

The truck 2 comprises a cab 6 mounted on a chassis 8. The cab 6 has a body 12 and a roof 13. Mounted on the roof 13 is a deflector 15 which is higher at the rear than the front so that, when the lorry 1 is moving forward, oncoming air is driven upwards.

The trailer 4 comprises a rectangular box-like goods container 10 mounted on a framework 11. The container 10 has elongate generally vertical sides 17 (only one shown in the figures), an elongate generally horizontal roof 16 and a front, forward-facing, generally vertical side 18. The container 10 is accessed through doors (not show) at the rear. The roof 16 has a forward most edge 20, which is where the roof 16 meets the front side 18; a front section 22, which is the section towards the forward-most edge 20; and, a rear section 23, which is at the opposite end of the roof 16.

An aerodynamic device 24 according to a first aspect of the invention is fitted to the container 10. The device 24 comprises an air guiding member 26 which is generally rectangular (in top view), being longer from front to rear than it is from side to side, and sheet- like in the sense of being relatively longer from front to rear and wider from side to side than it is thick from top to bottom. The member 26 is of generally uniform thickness over its entire length and width and has a forward section 28 and a rear section 30, which are angled with respect to one another. The member 26 is removably attached to the container 10 by an attachment structure in the form of a pair of arms 32, one to each side of the member 26, which are each fixed on to a corresponding side 17 of the container 10. The arms 32 hold the member 26 in a first, active position in spaced apart relation to the front section 22 of the roof 16. In this active position, the rear section 30 of the member 26 extends generally horizontally over the front section 22 of the roof 16, to a position forward of the forward most edge 20 of the roof 16. The forward section 28 of the roof 16 extends forward, from the rear section 30 and, because the front section 28 is angled with respect to the rear section 30, it extends downwards to a position below the forward most edge 20. An airway 34 is defined between the member 26 and the front section 22 of the roof 16.

Although not shown, the arms 32 are adjustable so that the member 26 can be held in other active positions with the member 26 still defining an airway but being a lesser or greater spacing from the front section 22 of the roof 16 and with the front and rear sections 28, 30 at different angles of inclination to the front section 22 of the roof 16. Also, the member 26 can be held at an inactive, stowed position where the member does not define an airway and is out of the way so as not to present, for example, a snag hazard. In addition, the arms 32 are so adapted that the device 24 can be removed from the container altogether as and when required. The device 24 was fitted to the vehicle 1 after it was manufactured.

When the lorry 1 travels forwards, oncoming air is guided by the deflector 16 and the member 26 through the airway 34. Airflow through the airway 34 promotes smooth airflow over the whole of the roof 16 to the rear of the device 24 and, in particular, minimises the tendency of the airflow to leave the surface of the roof and become turbulent. The effectiveness of the airway will vary with changes in the active position of the member 26.

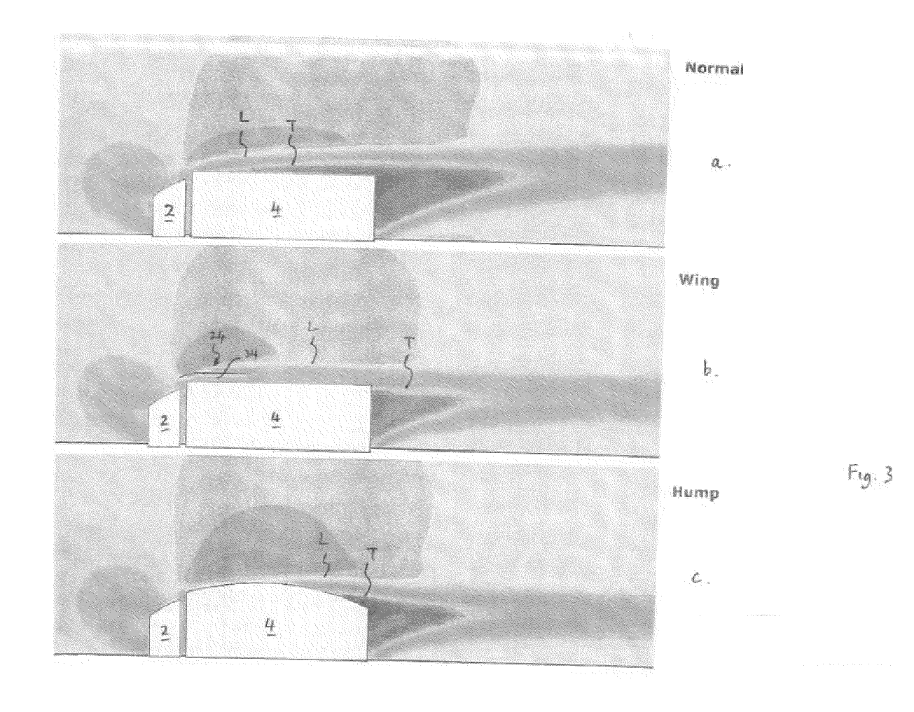

FIG. 3 shows how airflow over the roof of an articulated lorry (schematically represented as a truck 2 and a trailer 4) employing the device 24 according to the invention (FIG. 3b) compares to airflow over the roofs of lorries employing prior art devices (FIGS. 3a and 3c).

Regions of smooth, laminar airflow are indicated by the letter L and regions of turbulent airflow are indicated by the letter T. FIG. 3a shows airflow around a lorry employing only a cab roof mounted deflector. It can be seen that the airflow is turbulent across virtually the whole length of the roof. By adding a curved profile to the roof, as is shown in FIG. 3c, the extent of turbulent airflow across the roof is reduced. Employing the device 24 according to the invention, as shown in FIG. 3b, causes air to flow through the airway 34 defined by the device 24, which promotes smooth, laminar airflow of the whole of the roof to the rear of the device 24 by minimising the tendency of the airflow over the roof to leave the surface of the roof and become turbulent.

1. An aerodynamic device for fitting to a vehicle comprising a load compartment having a roof, wherein the roof has a front section which is the section of the roof towards an edge of the roof that is forward-most in relation to the direction of travel of the vehicle, the device comprising an air guiding member and an attachment structure, wherein the attachment structure is for attaching the member to a vehicle in a first, active position in spaced apart relation to the front section of the roof thereby to define an airway between the member and the front section of the roof.

2. A device according to claim 1, wherein the vehicle is a road vehicle.

3. A device according to claim 1, wherein an air deflector is mounted in front of the load compartment.

4. A device according to claim 1, wherein the member is sheet- or plate-like.

5. A device according to claim 1, wherein the member is curved from front to rear and/or side to side.

6. A device according to claim 5, wherein the curvature of the device is generally smoothly continuous or the member may comprise two or more planar sections, with each planar section being at an angle with respect to an adjacent planar section.

7. A device according to claim 1, wherein the member extends forward to a position forward of the forward-most edge of the roof.

8. A device according to claim 1 wherein the member extends backwards towards or to a rear section of the roof.

9. A device according to claim 7, wherein the member extends to a position below the forward-most edge of the roof.

10. A device according to claim 1 wherein the support structure comprises a pair of arms, each extending between a part of the member and a part of the vehicle.

11. A device according to claim 1, wherein the attachment structure is adjustable for attaching the member in other active positions in which the member defines an airway and is at a different spacing from and/or inclination to the front section of the load compartment roof and/or in an inactive, stowed position in which the member does not define an airway.

12. A device according to claim 1, wherein the support structure is adapted so that the device can be removed altogether from the load compartment.

13. A vehicle to which a device according to claim 1 has been fitted.

14. A method of fitting a device according to claim 1 to a vehicle.

15. An aerodynamic device, comprising an air guiding member to modify an aerodynamic signature of a vehicle to which the device is mounted, the member to define an air guiding channel between an underside thereof and a portion of the roof of the said vehicle whereby to induce a laminar airflow over the vehicle roof.
